(19) United States
(12) Patent Application Publication
(10) Pub. No.: US 2024/0364431 A1
(43) Pub. Date: Oct. 31, 2024

(54) METHOD OF SELECTING A SENSING NODE AND METHOD OF SELECTING A SENSING MODE

(71) Applicant: Rohde & Schwarz GmbH & Co. KG, Muenchen (DE)

(72) Inventors: Lilei WANG, Muenchen (DE); Meik KOTTKAMP, Muenchen (DE); Juergen SCHLIENZ, Muenchen (DE)

(73) Assignee: Rohde & Schwarz GmbH & Co. KG, Muenchen (DE)

(21) Appl. No.: 18/306,551

(22) Filed: Apr. 25, 2023

(51) Int. Cl. H04B 17/00

(52) U.S. Cl. CPC H04B 17/0085

(57) ABSTRACT

The present disclosure relates to a method of selecting a sensing node. A joint communication and sensing (JCAS) system is provided that includes a plurality of nodes. A sensing accuracy of the plurality of nodes is determined. The node out of the plurality of nodes is selected, which has the highest sensing accuracy as the sensing node that provides sensing results. Further, a method of selecting a sensing mode is disclosed.

### FIELD OF THE DISCLOSURE

Embodiments of the present disclosure relate to a method of selecting a sensing node. Further, embodiments of the present disclosure relate to a method of selecting a sensing mode.

### BACKGROUND

With current mobile network standards, for instance 5G or 5G-NR, objects can be controlled remotely via a respective network. New applications or services concern remote control and/or augmented/virtual reality, generally called extended reality-XR. Right now, these applications or services are mainly used in smaller restricted networks, particularly in industrial and commercial contexts.

With the advent of 6G, using remote control shall be made widely available to end consumers that use a user equipment. Application scenarios include controlling robots that take care of day-to-day tasks, coordinating drones, coordinated autonomous driving as well as affordable, universally accessible augmented and virtual reality.

A core capability introduced by 6G will be the symbiosis between mobile communication and mobile sensing. The participants of the 6G network, generally called nodes, must record their respective surroundings, particularly in 3D, while using sensors, for instance radar, spectroscopy and/or localization sensors. Furthermore, the participants must communicate with each other over the mobile networks in order to exchange data, particularly sensing results obtained.

Generally, there may be multiple nodes which could be used to sense the same object and provide the sensing service. Moreover, different modes used for sensing purposes may be provided. Actually, the question is which of the several participants is used for providing the respective sensing results and how the participant shall obtain the sensing results, namely which mode shall be used.

Accordingly, there is a need for determining an entity that provides sensing results used within the network, e.g. a sensing node and/or a sensing mode.

### SUMMARY

Embodiments of the present disclosure provide a method of selecting a sensing node. In an embodiment, the method comprises the steps of: providing a joint communication and sensing (JCAS) system comprising a plurality of nodes; determining a sensing accuracy of the plurality of nodes; and selecting the node out of the plurality of nodes, which has the highest sensing accuracy as the sensing node that provides sensing results.

The idea is to identify the respective node that provides the best sensing results such that the participants of the joint communication and sensing (JCAS) system, namely the respective nodes of the network, can rely on the sensing results obtained. In some embodiments, several nodes are provided that can be used to sense an object within the network in order to provide an underlying sensing service. In some embodiments, each of the several nodes could be (theoretically) used to sense the same object and to provide the sensing service. Therefore, it is necessary to identify the node that provides the optimal sensing results, which shall be used as the sensing node.

According to the present disclosure, the sensing node is inter alia selected based on its sensing performance, namely a determined sensing accuracy. The sensing accuracy is determined for several nodes, wherein the respective sensing accuracies are compared with each other in order to determine the node that has the highest sensing accuracy.

Consequently, confusion or performance degradation in the JCAS system can be avoided since it is clearly determined the sensing results of which node shall be used by the JCAS system, namely within the network. The solution is also efficient, as minimum signal overhead is required compared to other solutions known.

An aspect provides that the sensing accuracy depends, for example, on a feedback from a joint communication and sensing reference object. It is verified within the network which of the several nodes that may serve as the sensing node provides the sensing results with the highest accuracy. The sensing accuracy is determined based on the sensing results obtained, namely based on the feedback received from the JCAS reference object.

Generally, the JCAS system may comprise a transmitting node that transmits a sensing signal, for example towards the JCAS reference object. The JCAS system may also comprise a receiving node that receives the sensing signal, for example from the JCAS reference object. The receiving node may apply a sensing algorithm in order to obtain the sensing results. Alternatively, the receiving node forwards the sensing signal received to the transmitting node that applies the sensing algorithm in order to obtain the sensing results. Accordingly, the receiving node may be the sensing node that provides the sensing results at least indirectly, namely by means of raw data, e.g. the sensing data based on which the algorithm determines the sensing results.

The transmitting node and the receiving node may be different nodes or the same node. This depends on the mode.

In some embodiments, six modes may be feasible. In a first mode, the transmitting node is a base station that simultaneously is the receiving node. In a second mode, the transmitting node is a first base station, whereas the receiving node is a second base station different to the first base station. In a third mode, the transmitting node is a user equipment, whereas the receiving node is a base station. In a fourth mode, the transmitting node is a base station, whereas the receiving node is a user equipment. In a fifth mode, the transmitting node is a user equipment that simultaneously is the receiving node. In a sixth mode, the transmitting node is a first user equipment, whereas the receiving node is a second user equipment different to the first user equipment.

For instance, the accuracy is obtained by averaging the sensing results. In some embodiments, the sensing results from multiple base stations are averaged in order to identify the node that provides the highest sensing accuracy. The multiple base stations may communicate with the plurality of the nodes such that the multiple base stations obtain the sensing results that can be averaged accordingly.

Moreover, the accuracy may be obtained based on timing. The latest sensing results received, namely the recently received sensing results, are used for further processing, for instance by a sensing server, as these sensing results are deemed to be the most accurate ones. The sensing server may be connected with the base stations of the JCAS system.

According to another aspect, the accuracy may be obtained, for example, based on a distance from the respective node to the joint communication and sensing reference object. It is assumed that the node having the shortest distance to the respective object is the one that provides the best sensing results.

In addition, the accuracy may be obtained based on a direction of travel. In case of a moving object or moving node, the respective travel direction may be taken into consideration in order to select the respective node that acts as the sensing node. Accordingly, position data of the nodes is available. In some embodiments, the sensing server may access the position data of the plurality of nodes, which enables the sensing server to select the sensing node based on the direction of travel.

A further aspect provides that, for example, in cases where the sensing results of a specific node are sensitive, at least one other node transmits its sensing results to the specific node. In case of more than two nodes in total, the other nodes transmit their sensing results to the specific node. Therefore, data privacy aspects are also taken into consideration, as the specific node having the sensitive sensing results does not distribute its sensing results within the network, namely to the other node(s) due to data policies. The sensitive sensing results may relate to private data obtained by a user equipment. Accordingly, a base station that is also able to sense the same object may forward its sensing results to the user equipment.

The specific node may compare the sensing results obtained from the at least one other node to its sensing results. Therefore, the specific node itself is enabled to compare the different sensing results obtained within the network in order to evaluate whether its sensing results has a higher sensing accuracy compared to the sensing results of the other node(s) in the JCAS system or in the network of the JCAS system.

Therefore, the specific node may determine a comparison result when comparing the sensing results obtained from the at least one other node to its sensing results. The comparison result may be an abstract measure, for instance a value or a vector, which does not contain any information and/or data associated with the sensitive sensing results. Therefore, the specific node may be allowed to distribute the comparison result within the network, namely to the at least one other node.

The abstract measure may correspond to a number of different levels that indicate the degree of correlation. For instance, five levels are provided, wherein level 5 indicates that the measurement results are very correlated and level 1 indicates that the measurement results are not correlated.

A further aspect provides that the specific node forwards, for example, the comparison result to the at least one other node. Therefore, the information concerning the node having the highest sensing accuracy can be shared within the network, but the sensitive data/information is still kept private.

Generally, multiple nodes of the plurality of nodes compare sensing results obtained from other nodes to their respective sensing results, wherein the multiple nodes each determine a comparison result when comparing the results obtained from the other nodes to their respective sensing results. The multiple nodes may each have sensitive sensing results that have to be kept private such that abstract comparison results of the multiple nodes are provided within the network. These abstract comparison results can be compared among each other and with sensing results of nodes allowed to forward their sensing results within the network. Alternatively or additionally, the different sensing results may be abstracted measures that can be compared with each other easily.

The network may negotiate with a node, for instance a user equipment, about which sensing parameters can be obtained by the node. In some embodiments, the sensing parameters may not be matched between network and node. The network can sense distance, velocity, radar cross section (RCS), angle but the node is only able to sense velocity. Accordingly, the network may ask multiple nodes to report the results to cover all sensing parameters.

A further aspect provides that, for example, in cases where multiple sensing modes are available, it is defined which of the multiple sensing modes is selected. As indicated above, six different sensing modes may be provided in total, which depends on the type of node. Depending on the respective type of the node transmitting the sensing signal, three different modes may be applicable. The transmitting node itself may define which of the different modes shall be used for providing the sensing results with the highest sensing accuracy.

Generally, a sensing server may define which sensing modes shall be used for obtaining different sensing results.

In some embodiments, it is also defined how to handle the sensing results obtained in the selected sensing mode. For instance, the transmitting node or the sensing server also decides how the different sensing results are handled within the network. This means it is defined if all sensing results of all different sensing modes are forwarded within the network or only the one that provides the sensing results with the highest sensing accuracy.

A further aspect provides that a node, for example, asks the sensing node to feedback sensing results gathered in the multiple sensing modes. The respective node asking the sensing node may relate to the transmitting node, for instance a base station. The sensing node may be a user equipment. Via the network, the base station, namely the node that asks the sensing node, receives the sensing results associated with the multiple sensing modes of the sensing node, e.g. the user equipment. The sensing node asked by the node feedbacks the respective sensing results so that the asking node, namely the base station, is generally enabled to further process the different sensing results gathered.

In some embodiments, the node compares the sensing results received from the sensing node in order to identify the sensing mode that has the highest sensing accuracy. The computational power necessary to identify the sensing mode with the highest sensing accuracy can be outsourced to the node, for instance the base station.

In some embodiments, the asking node, for instance the base station, is able to ask the sensing node, for instance the user equipment, to turn on two modes, e.g. mode 2 and mode 3, and to feedback all the sensing results so that the asking node compares the sensing results obtained from all modes.

In some embodiments, the sensing node only forwards the sensing results of the sensing mode that has the best performance compared to the sensing results of the other sensing modes. Therefore, the sensing node itself provides a distinction which of the different sensing results corresponds to the highest sensing accuracy.

Another aspect provides that a node, for example, asks the sensing node to feedback a result derived from the sensing results gathered by the sensing node rather than the sensing results themselves. Therefore, the sensing results themselves are not forwarded, but a result that has been derived from the sensing results. For instance, integrated results of several sensing results obtained from the different sensing modes, an average of several sensing results obtained from the different sensing modes or only the sensing results with the better sensing accuracy, are forwarded to the node asking the sensing node.

Again, the node asking the sensing node may be a base station. The asking node, namely the base station, is able to ask the sensing node, e.g. the user equipment, to turn on two modes, but only feedbacks the integrated results of these two modes, for example based on an average operation and/or better performance, namely only the searching results with better sensing performance.

Generally, the respective nodes of the network or the general communication and sensing system may be base stations and/or user equipment. The respective participants of the network may interact with each other while communicating with each other and simultaneously exchanging sensing data.

Further, embodiments of the present disclosure also provide a method of selecting a sensing mode. In an embodiment, the method comprises the steps of providing a joint communication and sensing (JCAS) system comprising at least one node and a plurality of modes; determining a sensing accuracy of the plurality of modes; and selecting the mode out of the plurality of modes, which has the highest sensing accuracy as the sensing mode to provide sensing results.

As indicated above, six modes may be feasible which depends on the type of node, namely either base station or user equipment. In a first mode, the transmitting node is a base station that simultaneously is the receiving node. In a second mode, the transmitting node is a first base station, whereas the receiving node is a second base station different to the first base station. In a third mode, the transmitting node is a user equipment, whereas the receiving node is a base station. In a fourth mode, the transmitting node is a base station, whereas the receiving node is a user equipment. In a fifth mode, the transmitting node is a user equipment that simultaneously is the receiving node. In a sixth mode, the transmitting node is a first user equipment, whereas the receiving node is a second user equipment different to the first user equipment.

Generally, a sensing server may be provided that performs the selection while receiving the different sensing results obtained within the network, for example in case several nodes sense the same object.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an overview of a joint communication and sensing system that has a network of several nodes in accordance with an embodiment of the disclosure;

FIG. 2 schematically shows an illustrative example of a first embodiment of a method according to the present disclosure,

FIG. 3 illustratively shows a second embodiment of the method according to the present disclosure, and

FIG. 4 schematically shows a third embodiment of the method according to the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

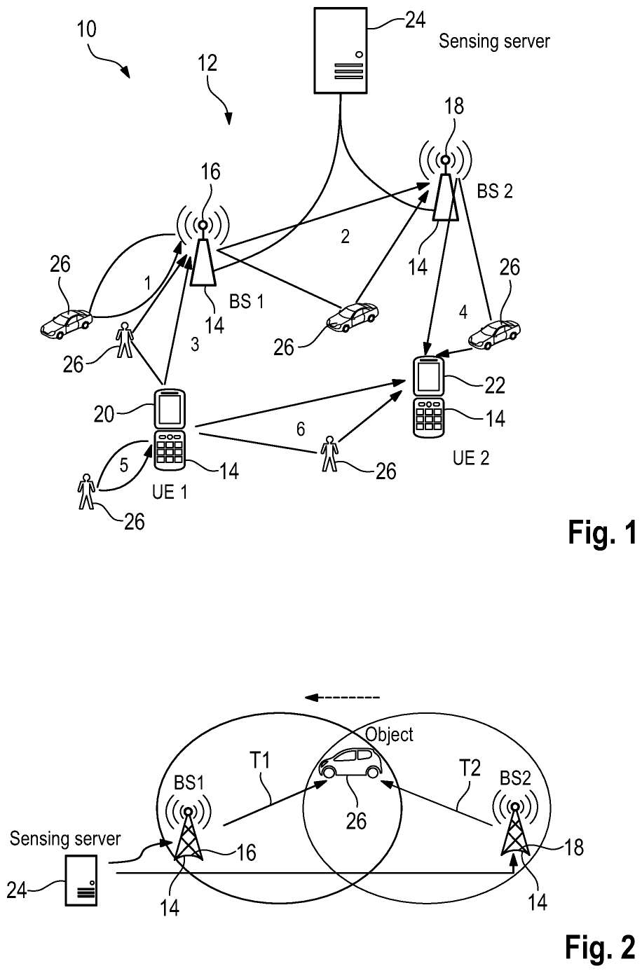

In FIG. 1, a representative example of a joint communication and sensing (JCAS) system 10 is shown, which comprises a network 12 with several nodes 14. In the shown embodiment, the nodes 14 correspond to a first base station 16 (“BS1”), a second base station 18 (“BS2”), a first user equipment 20 (“UE1”) and a second user equipment 22 (“UE2”).

The joint communication and sensing system 10, for example the network 12, comprises a sensing server 24 that is connected with the base stations 16, 18. In addition, joint communication and sensing (JCAS) reference objects 26 are shown in FIG. 1, which relate to vehicles or persons. The respective nodes 14 may correspond to transmitting nodes and/or receiving nodes, which depends on a respective sensing mode applied. FIG. 1 illustrates six different sensing modes that are indicated by the numbers “1” to “6” as well as the respective arrows between the nodes 14 and the JCAS reference objects 26. Each mode will be described in more detail below.

In a first mode “1”, the transmitting node is the first base station 16 that transmits a sensing signal to the JCAS object 26, e.g. a vehicle, and simultaneously receives the sensing signal from the JCAS object 26. Hence, the first base station 16 is also the receiving node.

In a second mode “2”, the transmitting node is the first base station 16 that transmits the sensing signal, for example to the JCAS object 26, e.g. a vehicle. The receiving node is the second base station 18 that is located at a different position compared to the first base station 16. The second base station 18 acting as the receiving node receives the sensing signal from the JCAS object 26 as well as directly from the first base station 16 acting as the transmitting node.

In a third mode “3”, the transmitting node is the first user equipment 20 that transmits the sensing signal, for example to the JCAS object 26, e.g. a person. The receiving node is the first base station 16. The first base station 16 acting as the receiving node receives the sensing signal from the JCAS object 26 as well as directly from the first user equipment 20 acting as the transmitting node.

In a fourth mode “4”, the transmitting node is the second base station 18 that transmits the sensing signal, for example to the JCAS object 26, e.g. a vehicle. The receiving node is the second user equipment 22. The second user equipment 22 acting as the receiving node receives the sensing signal from the JCAS object 26 as well as directly from the second base station 18 acting as the transmitting node.

In a fifth mode “5”, the transmitting node is the first user equipment 20 that transmits a sensing signal to the JCAS object 26, e.g. a person, and simultaneously receives the sensing signal from the JCAS object 26. Hence, the first user equipment 20 is also the receiving node.

In a sixth mode “6”, the transmitting node is the first user equipment 20 that transmits the sensing signal, for example to the JCAS object 26, e.g. a person. The receiving node is the second user equipment 22 that is located at a different position compared to the first user equipment 20. The second user equipment 22 acting as the receiving node receives the sensing signal from the JCAS object 26 as well as directly from the first user equipment 20 acting as the transmitting node.

Accordingly, the base stations 16, 18 as well as the user equipment 20, 22 may act as the sensing node.

In FIG. 2, a first embodiment of the method of selecting a sensing node is shown, as two base stations, namely the first base station 16 as well as the second base station 18 sense the same object 26, e.g. a vehicle. The first base station 16 senses the object 26 at time T1, whereas the second base station 18 senses the same object 26 at time T2 that is later than T1. Hence, the sensing results obtained from the second base station 18 are more actual than the ones of the first base station 16.

The sensing server 24 that receives both the sensing results of the first base station 16 and the sensing results of the second base station 18 determines which of the plurality of nodes 14, namely the first base station 16 and the second base station 18, has the higher sensing accuracy. In the respective embodiment, the sensing server 24 relies on the criteria of time such that the sensing results of the second base station 18 are adopted by the sensing server 24. Therefore, the second base station 18 is selected as the sensing node that provides the sensing results.

In an alternative embodiment, the sensing accuracy may be obtained based on a direction of travel of the object 26. As indicated in FIG. 2, the object 26 is orientated towards the first base station 16 as also indicated by the dashed arrow. Accordingly, the sensing server 24 may select the first base station 16 as the sensing node that provides sensing results while determining that the sensing results of the first base station 16 do have the higher sensing accuracy due to the direction of travel of the object 26.

In this alternative, the sensing server 24 relies on the criteria of direction of travel such that the sensing results of the first base station 16 are adopted by the sensing server 24. Therefore, the first base station 16 is selected in the alternative described as the sensing node that provides the sensing results.

In another alternative embodiment, the sensing accuracy may be obtained based on a distance of the nodes 14, namely the first base station 16 and the second base station 18, to the object 26. It is assumed that the node 14 being closer to the object 26 provides sensing results with higher sensing accuracy. Therefore, the node 14 is selected in the alternative described as the sensing node that has the smaller distance to the object 26.

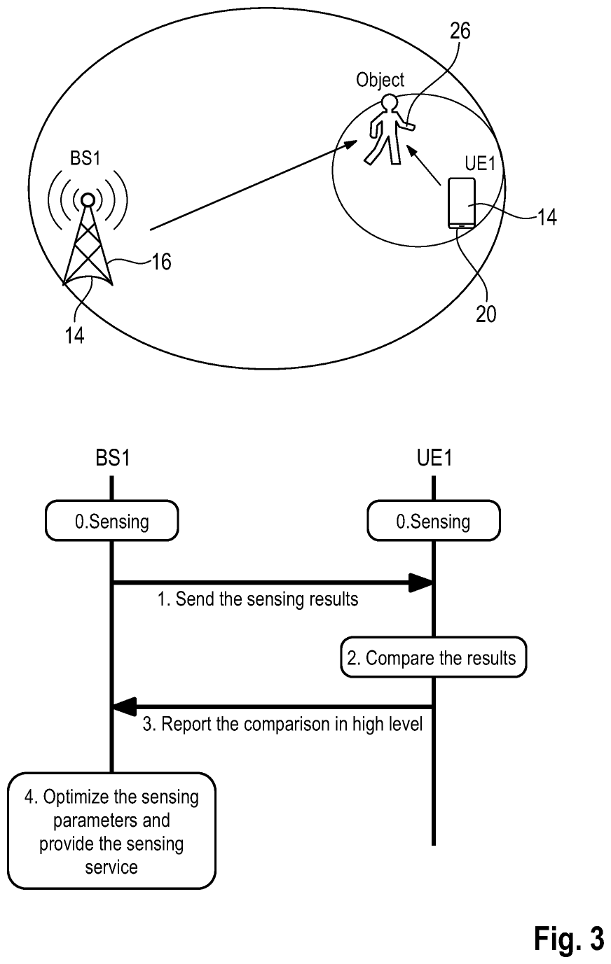

In FIG. 3, a second embodiment is illustrated. In this embodiment, two nodes 14, namely the first base station 16 as well as the first user equipment 20, simultaneously sense the same object 26, e.g. a person. For instance, the sensing results obtained by the first user equipment 20 may be sensitive due to a policy applied, e.g. human beings' health status.

Due to data privacy, the first user equipment 20 is not allowed to directly report its sensing results to the other node 14, namely the first base station 16. Accordingly, the first user equipment 20 corresponds to a specific node 14 due to the sensitive sensing results.

The base station 16, namely the other node 14, sends its sensing results to the user equipment 20 that compares the results obtained from the other node 14, namely the first base station 16, to its own sensing results.

The first user equipment 20 determines a comparison result that can be used for further processing. Afterwards, the first user equipment 20 forwards the comparison result to the other node 14, namely the first base station 16.

The comparison result may be reported in high level such that the sensitive data/information gathered by the first user equipment 20 is not forwarded to the other node 14, namely the first base station 16. The high level report may relate to an abstract measure, e.g. a value or a vector. In some embodiments, the comparison result may indicate how well the sensing results compared are correlated.

The first base station 16 is enabled to process the comparison result, thereby retrieving information from the comparison results. Based thereon, the first base station 16 may optimize sensing parameters and provide the sensing service, for example in an optimized manner.

Of course, the second base station 18 and/or the second user equipment 22 may be used instead of the first base station 16 and/or the first user equipment 20.

In cases where more than two nodes 14 are provided, e.g. as shown in FIG. 1, multiple nodes 14 of the plurality of nodes 14 may compare sensing results obtained from other nodes 14 to their respective sensing results. The multiple nodes 14 each determine a comparison result when comparing the sensing results obtained from the other nodes 14 to their respective sensing results.

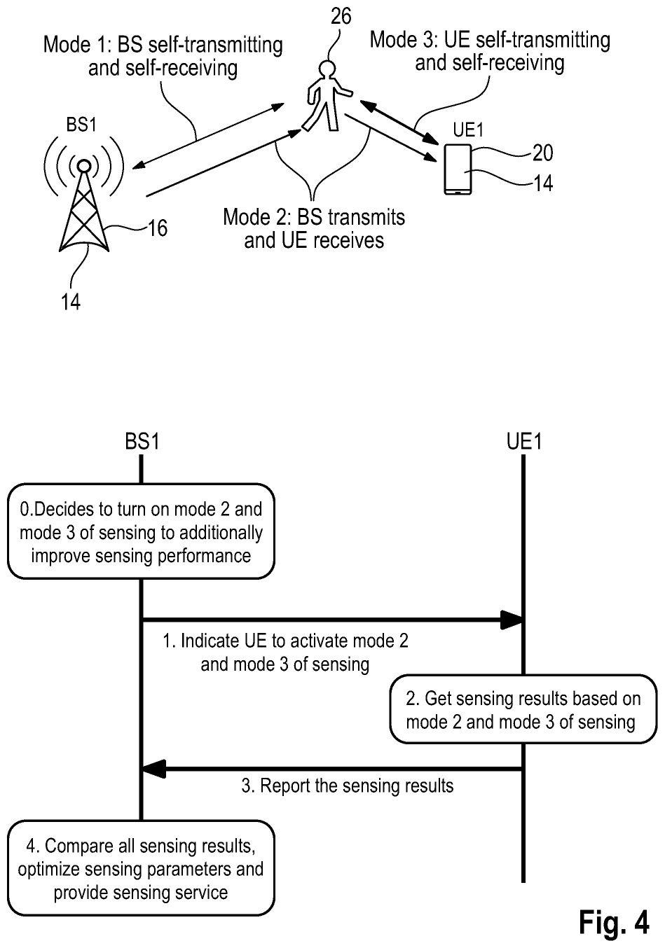

In FIG. 4, a third example embodiment of the method of selecting a sensing node is shown. This embodiment also shows the method of selecting a sensing mode.

In some embodiments, three different modes are illustrated that can be used to sense the same object 26. The nodes 14 may relate to the first base station 16 and the first user equipment 20. Of course, the second base station 18 and/or the second user equipment 22 may be used instead of the first base station 16 and/or the first user equipment 20.

The first mode shown relates to the first base station 16 self-transmitting the sensing signal and self-receiving the sensing signal. The second mode shown may relate to the first base station 16 transmitting the sensing signal that is received by the first user equipment 20. The third mode shown may relate to the user equipment 20 self-transmitting the sensing signal and self-receiving the sensing signal. Accordingly, the three modes shown in FIG. 4 substantially correspond to the first mode “1”, the fourth mode “4” and the fifth mode “5” shown in FIG. 1.

The first base station 16 may decide to turn on mode 2 and mode 3 in order to additionally obtain information that may possibly be used to improve sensing performance. Accordingly, the first base station 16 may indicate the first user equipment 20 to activate mode 2 and mode 3 respectively such that the first user equipment 20 is enabled to also obtain sensing results, for example based on mode 2 and mode 3.

The first user equipment 20 afterwards reports the respective sensing results to the first base station 16 that receives several different sensing results which can be compared with each other in order to optimize sensing and providing an optimized sensing service.

In the shown embodiment, the first base station 16 defines which of the multiple sensing modes is selected by indicating the first user equipment 20 to activate the respective modes. The first base station 16 may be controlled by the sensing server 24 accordingly.

Moreover, the first base station 16 also defines how to handle the sensing results obtained in the selected sensing modes, as the first base station 16 indicates that the first user equipment 20 shall forward the sensing results to the first base station 16. Again, the first base station 16 may be controlled by the sensing server 24 accordingly. Alternatively, the first user equipment 20 defines how to handle the sensing results.

In other words, the first base station 16 asks the first user equipment 20 to feedback the sensing results gathered in the multiple sensing modes used for obtaining sensing results, wherein the first base station 16 compares the sensing results obtained.

In an alternative embodiment, the first base station 16 asks the first user equipment 20 to feedback a result derived from the sensing results gathered rather than the sensing results themselves. The respective result may relate to a processed parameter or measure that was derived from the sensing results.

For instance, the first user equipment 20 only forwards the sensing results of the sensing mode that has the best performance compared to the sensing results of the other sensing modes.

Accordingly, a method of selecting a sensing mode may be performed, as a sensing accuracy of the plurality of modes is determined. For further processing, the mode out of the plurality of modes is selected, which has the highest sensing accuracy as the sensing mode to provide sensing results, for instance by the sensing server 24.

In embodiments and alternatives described, the sensing accuracy depends on the feedback from the joint communication and sensing reference object 26. Consequently, it can be determined which of several nodes 14 and/or several modes shall be used for providing the sensing results within the network 12. Hence, conflicts can be avoided appropriately. The respective selection may be based on the type of node 14, data privacy aspects (sensitive sensing results) and sensing performance.

Certain embodiments disclosed herein include systems, apparatus, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry.” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof.

In an embodiment, circuitry includes hardware circuit implementations (e.g., implementations in analog circuitry, implementations in digital circuitry, and the like, and combinations thereof). In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implemented the functionality or methodology described herein.

Various embodiments of the present disclosure or the functionality thereof may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably). Such non-transitory computer-readable storage media include all computer-readable media (including volatile and non-volatile media).

Embodiments of the present disclosure, or components thereof, may also take the form of an apparatus, system, computing device, computing entity, and/or the like executing instructions stored on computer-readable storage media to perform certain steps or operations. The computer-readable media include cooperating or interconnected computer-readable media, which exist exclusively on a processing or processor system or distributed among multiple interconnected processing or processor systems that may be local to, or remote from, the processing or processor system. However, embodiments of the present disclosure, or components thereof, may also take the form of an entirely hardware embodiment performing certain steps or operations.

Various embodiments are described above with reference to block diagrams and/or flowchart illustrations of apparatuses, methods, systems, and/or computer program instructions or program products. It should be understood that each block of any of the block diagrams and/or flowchart illustrations, respectively, or portions thereof, may be implemented in part by computer program instructions, e.g., as logical steps or operations executing on one or more computing devices. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein.

These computer program instructions may also be stored in one or more computer-readable memory or portions thereof, such as the computer-readable storage media described above, that can direct one or more computers or computing devices or other programmable data processing apparatus(es) to function in a particular manner, such that the instructions stored in the computer-readable memory produce an article of manufacture including computer-readable instructions for implementing the functionality specified in the flowchart block or blocks.

The computer program instructions may also be loaded onto one or more computers or computing devices or other programmable data processing apparatus(es) to cause a series of operational steps to be performed on the one or more computers or computing devices or other programmable data processing apparatus(es) to produce a computer-implemented process such that the instructions that execute on the one or more computers or computing devices or other programmable data processing apparatus(es) provide operations for implementing the functions specified in the flowchart block or blocks and/or carry out the methods described herein.

It will be appreciated that the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof.

Accordingly, blocks of the block diagrams and/or flowchart illustrations support various combinations for performing the specified functions, combinations of operations for performing the specified functions and program instructions for performing the specified functions. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In some embodiments, the network 12, the nodes 14, etc., or components thereof, are configured to perform one or more method steps of the claimed subject matter. In some embodiments, one or more of these components includes one or more computer-readable media containing computer readable instructions embodied thereon that, when executed by one or more computer circuits, sometimes referred to as computing devices, cause the one or more computer circuits to perform one or more method steps of the claimed subject matter. In some embodiments, the one or more computer circuits includes a microprocessor, a microcontroller, a central processing unit, a graphics processing unit (GPU), a digital signal processor (DSP), an ASIC, etc.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near.” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C.” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method of selecting a sensing node, comprising the steps of:
providing a joint communication and sensing (JCAS) system comprising a plurality of nodes;
determining a sensing accuracy of the plurality of nodes; and
selecting the node out of the plurality of nodes, which has the highest sensing accuracy as the sensing node that provides sensing results.

2. The method according to claim 1, wherein the sensing accuracy depends on a feedback from a joint communication and sensing reference object.

3. The method according to claim 1, wherein the accuracy is obtained by averaging the sensing results.

4. The method according to claim 1, wherein the accuracy is obtained based on timing.

5. The method according to claim 1, wherein the accuracy is obtained based on a distance from the respective node to the joint communication and sensing reference object.

6. The method according to claim 1, wherein the accuracy is obtained based on a direction of travel.

7. The method according to claim 1, wherein, in case sensing results of a specific node are sensitive, at least one other node transmits its sensing results to the specific node.

8. The method according to claim 7, wherein the specific node compares the sensing results obtained from the at least one other node to its sensing results.

9. The method according to claim 8, wherein the specific node determines a comparison result when comparing the sensing results obtained from the at least one other node to its sensing results.

10. The method according to claim 9, wherein the specific node forwards the comparison result to the at least one other node.

11. The method according to claim 1, wherein multiple nodes of the plurality of nodes compare sensing results obtained from other nodes to their respective sensing results, and wherein the multiple nodes each determine a comparison result when comparing the sensing results obtained from the other nodes to their respective sensing results.

12. The method according to claim 1, wherein, in case multiple sensing modes are available, it is defined which of the multiple sensing modes is selected.

13. The method according to claim 12, wherein it is defined how to handle the sensing results obtained in the selected sensing modes.

14. The method according to claim 12, wherein a node asks the sensing node to feedback sensing results gathered in the multiple sensing modes.

15. The method according to claim 14, wherein the node compares the sensing results received from the sensing node.

16. The method according to claim 12, wherein the sensing node only forwards the sensing results of the sensing mode that has the best performance compared to the sensing results of the other sensing modes.

17. The method according to claim 12, wherein a node asks the sensing node to feedback a result derived from the sensing results gathered by the sensing node rather than the sensing results themselves.

18. The method according to claim 1, wherein the nodes comprise base stations and/or user equipment.

19. A method of selecting a sensing mode, comprising the steps of:
providing a joint communication and sensing (JCAS) system comprising at least one node and a plurality of modes,
determining a sensing accuracy of the plurality of modes, and
selecting the mode out of the plurality of modes, which has the highest sensing accuracy as the sensing mode to provide sensing results.
